(19) United States
(12) Patent Application Publication
(10) Pub. No.: US 2026/0250093 A1
(43) Pub. Date: Aug. 27, 2026

(54) DIAGNOSTIC APPARATUS, SYSTEM, AND DIAGNOSTIC METHOD

(71) Applicant: SEIKO EPSON CORPORATION, Tokyo (JP)

(72) Inventors: Fumiya TERAI, Azumino (JP); Satoshi NEGISHI, Shiojiri (JP); Atsushi MISAWA, Matsumoto (JP); Taiga NOBORIO, Asahi-mura (JP); Takayuki YAZAWA, Shiojiri (JP)

(21) Appl. No.: 19/546,486

(22) Filed: Feb. 23, 2026

(30) Foreign Application Priority Data
Feb. 25, 2025 (JP) 2025-028009

(51) Int. Cl. B65H 7/06; H04N 1/00

(52) U.S. Cl. CPC B65H 7/06; H04N 1/00034; H04N 1/00037; H04N 1/00068; B65H 2551/20

(57) ABSTRACT

A diagnostic apparatus includes a communication section that communicates with a transport apparatus, an acquisition section that acquires measurement data indicating a period of time required to transport the medium in a predetermined transport section, a storage that stores the acquired measurement data, a setting section that sets a determination criterion used for error determination of the transport apparatus by time-series analysis performed on the stored measurement data, a determination section that determines, when measurement data is newly acquired from the transport apparatus, an error relating to transport of the new measurement data based on the new measurement data and the determination criterion, and a notification section that notifies a result of the determination of the error. The setting section sets the determination criterion at a time point when the new measurement data is acquired based on a tendency of a temporal change of the stored measurement data.

### CROSS REFERENCE TO RELATED APPLICATIONS

The present application is based on, and claims priority from JP Application Serial Number 2025-028009, filed February 25, 2025, the disclosure of which is hereby incorporated by reference herein in its entirety.

### BACKGROUND

### Technical Field

The present disclosure relates to a diagnostic apparatus, a system, and a diagnostic method.

### Related Art

In the related art, there is a transport apparatus which detects a transport error of a sheet in a transport device which transports a recording sheet (hereinafter, referred to as a sheet) in a printer or the like. JP-A-2005-194037 discloses a technique of measuring a transport time required for a sheet to reach a predetermined position and determining that a paper jam has occurred when the transport time exceeds a predetermined reference value.

In the related art, an error relating to transport has merely been determined as a simple paper jam, and the error may not be appropriately determined in consideration of a state of the apparatus that changes over time.

### SUMMARY

According to an aspect of the present disclosure, a diagnostic apparatus includes a communication section that communicates with a transport apparatus that transports a medium, an acquisition section that acquires measurement data indicating a period of time required to transport the medium in a predetermined transport section on a transport path of the transport apparatus, a storage that stores the acquired measurement data, a setting section that sets a determination criterion used for error determination of the transport apparatus by time-series analysis performed on the stored measurement data, a determination section that determines, when measurement data is newly acquired from the transport apparatus, an error relating to transport of the new measurement data based on the new measurement data and the determination criterion, and a notification section that notifies a result of the determination of the error. The setting section sets the determination criterion at a time point when the new measurement data is acquired based on a tendency of a temporal change of the stored measurement data.

According to another aspect of the present disclosure, in a system in which a transport apparatus that transports a medium and an information processing apparatus are connected to each other via a network, the information processing apparatus includes a communication section that communicates with the transport apparatus, an acquisition section that acquires measurement data indicating a period of time required to transport the medium in a predetermined transport section on a transport path of the transport apparatus, a storage that stores the acquired measurement data, a setting section that sets a determination criterion used for error determination of the transport apparatus by time-series analysis performed on the stored measurement data, a determination section that determines, when measurement data is newly acquired from the transport apparatus, an error relating to transport of the new measurement data based on the new measurement data and the determination criterion, and a notification section that notifies a result of the determination of the error. The setting section sets the determination criterion at a time point when the new measurement data is acquired based on a tendency of a temporal change of the stored measurement data.

According to a further aspect of the present disclosure, a diagnostic method causes a computer to execute acquiring measurement data indicating a period of time required to transport a medium in a predetermined transport section on a transport path of a transport apparatus that transports the medium, storing the acquired measurement data in a storage, setting a determination criterion used for error determination of the transport apparatus by time-series analysis performed on the stored measurement data, determining, when measurement data is newly acquired from the transport apparatus, an error relating to transport of the new measurement data based on the new measurement data and the determination criterion, and notifying a result of the determination of the error. In the setting, the determination criterion at a time point when the new measurement data is acquired is set based on a tendency of a temporal change of the stored measurement data.

### BRIEF DESCRIPTION OF THE DRAWINGS

FIG. 1 is a diagram illustrating an example of a system according to an embodiment.

FIG. 2 is a diagram illustrating an example of a functional configuration of a printer.

FIG. 3 is a diagram illustrating an example of a functional configuration of a server apparatus.

FIG. 4 is a flowchart illustrating an example of an operation of the server apparatus.

FIG. 5 is an explanatory view illustrating a sensor passing time.

FIG. 6 is an explanatory view illustrating an example of measurement data.

FIG. 7 is an explanatory view illustrating an example of measurement data.

FIG. 8 is an explanatory view illustrating an example of measurement data.

FIG. 9 is an explanatory view illustrating an example of measurement data.

FIG. 10 is an explanatory view illustrating an example of measurement data.

FIG. 11 is an explanatory view illustrating an example of measurement data.

FIG. 12 is an explanatory view illustrating an example of measurement data.

FIG. 13 is an explanatory view illustrating an example of measurement data.

FIG. 14 is an explanatory view illustrating an example of history data.

### DESCRIPTION OF EMBODIMENTS

Hereinafter, embodiments according to the present disclosure will be described in detail with reference to the drawings. However, an unnecessarily detailed description may be omitted. For example, detailed description of well-known matters or redundant description of substantially the same configuration may be omitted.

In the description of the present disclosure, general abbreviations may be used for description. For example, LAN is an abbreviation for Local Area Network. CPU is an abbreviation for Central Processing Unit. MPU is an abbreviation for Micro Processing Unit. PC is an abbreviation for Personal Computer. ROM is an abbreviation for Read Only Memory. RAM is an abbreviation for Random Access Memory. The HDD is an abbreviation for Hard Disk Drive. SSD is an abbreviation for Solid State Drive. SoC is an abbreviation for System-on-a-Chip. The DSP is an abbreviation for Digital Signal Processor.

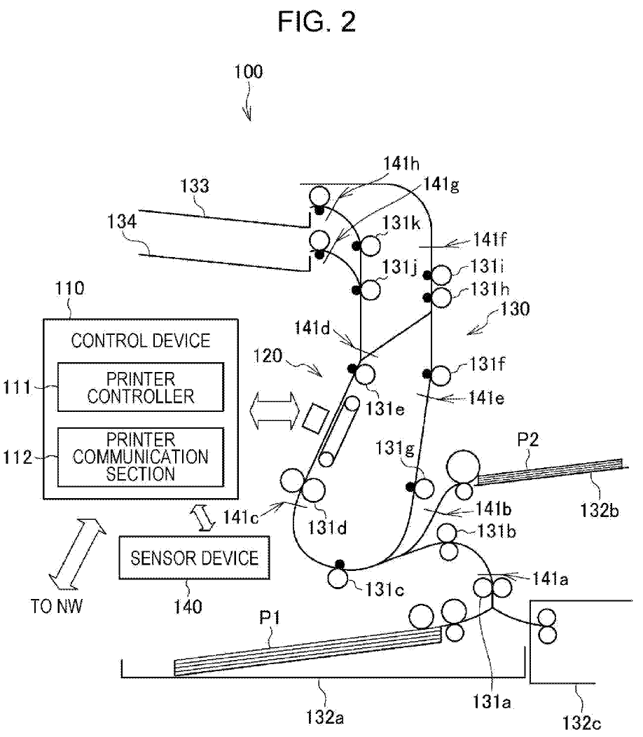

In the description of the present disclosure, components having the same or similar functions may be distinguished from each other by adding alphanumeric characters or the like to the ends of reference numerals. In addition, in the description of embodiments, a plurality of components having the same or similar functions may be described without distinction by omitting alphanumeric characters and the like at the ends of reference numerals. For example, in FIG. 2, transport rollers 131a to 131k are referred to as transport rollers 131 when not particularly distinguished. Similarly, sensors 141a to 141h are referred to as measurement devices 141 when not particularly distinguished.

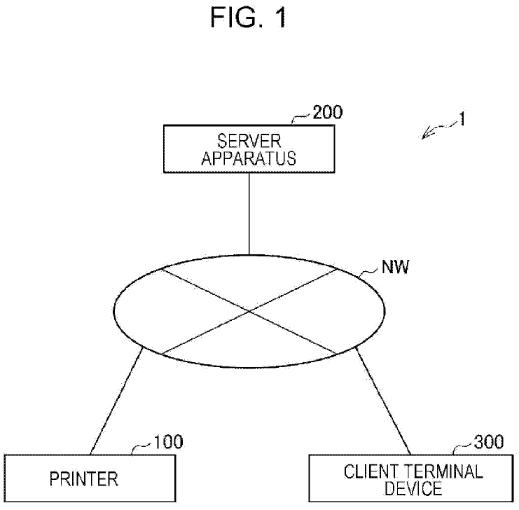

FIG. 1 is a configuration diagram of a system according to an embodiment. As illustrated in FIG. 1, the system 1 includes a printer 100, a server apparatus 200, and a terminal device 300. The printer 100, the server apparatus 200, and the terminal device 300 are communicably connected to each other via a network NW. The network NW is, for example, the Internet or a LAN.

The printer 100 includes a transport mechanism that transports a sheet and a print mechanism that performs printing on the transported sheet by a predetermined printing method, such as an electrophotographic method or an ink jet method. The printer 100 is an example of a transport apparatus that transports a sheet which is an example of a medium. The transport apparatus may be incorporated as a transport mechanism in the printer 100 or may be an independent device separated from the printer 100. In addition, the medium is not limited to paper, and may be, for example, cloth.

FIG. 2 is a diagram illustrating an example of a functional configuration of the printer 100. As illustrated in FIG. 2, the printer 100 includes a control device 110, a print mechanism 120, a transport mechanism 130, and a sensor device 140.

The control device 110 is a processor, such as a CPU or an MPU, that executes a program. The control device 110 provides functions as a printer controller 111 and a printer communication section 112 by, for example, the CPU executing a program.

The printer controller 111 is a processing section that controls an operation of the printer 100. For example, the printer controller 111 performs printing on sheets P1 and P2 by driving the transport mechanism 130 and the print mechanism 120 based on a print request issued by the server apparatus 200, the terminal device 300, or the like connected via the network NW.

Specifically, upon receiving the print request, the printer controller 111 drives predetermined transport rollers 131 of the transport mechanism 130 to transport the sheets P1 and P2 mounted on sheet feed cassettes 132a and 132c and a sheet feed tray 132b to the print mechanism 120. Subsequently, the printer controller 111 performs printing on the transported sheets P1 and P2 in the print mechanism 120 based on a print condition included in the print request. Thereafter, the printer controller 111 drives the predetermined transport rollers 131 of the transport mechanism 130 and transports the sheets P1 and P2 after printing in the print mechanism 120 to the first sheet discharge tray 133.

The printer communication section 112 is a processing section that performs communication with an external device, such as the server apparatus 200 and the terminal device 300, connected via the network NW. Specifically, the printer communication section 112 receives various requests and instructions, such as a print request, issued by the server apparatus 200 or the terminal device 300. The printer communication section 112 makes a response to a request from the server apparatus 200 or the terminal device 300. For example, in a case where there is an acquisition request for measurement data measured by the sensor device 140 from the server apparatus 200 or the terminal device 300, the printer communication section 112 transmits the measurement data to the request source together with identification information indicating a sensor of the acquisition source.

The print mechanism 120 performs printing on the sheets P1 and P2 transported by the transport mechanism 130 by a predetermined printing method, such as an electrophotographic method or an ink jet method, under the control of the printer controller 111.

The transport mechanism 130 includes the sheet feed cassettes 132a and 132c, and the sheet feed tray 132b on which the sheets P1 and P2 are mounted, and transport rollers 131a to 131k that transport the sheets P1 and P2.

To be specific, the transport rollers 131a to 131d transport the sheets P1 and P2 mounted on the sheet feed cassettes 132a and 132c or the sheet feed tray 132b to the print mechanism 120.

The transport rollers 131e to 131k transport the sheets P1 and P2 printed by the print mechanism 120 from the print mechanism 120 to the first sheet discharge tray 133 and the second sheet discharge tray 134. Alternatively, the transport rollers 131e to 131k reverse the sheets P1 and P2 printed by the print mechanism 120 and transport the sheets to the print mechanism 120 again.

The sensor device 140 detects various states of the printer 100, and includes, for example, a temperature and humidity sensor that detects a temperature and humidity of the printer 100. In addition, the sensor device 140 includes measurement devices 141 for measuring transport times for individual predetermined transport sections in which the sheets P1 and P2 are transported in the transport mechanism 130. The measurement devices 141 are optical sensors or the like that are provided at both ends of the transport sections and detect the sheets P1 and P2 that have passed over the sensors.

Specifically, the sensors 141a and 141c measure a transport time required for transport of the sheets P1 and P2 transported via the transport rollers 131b and 131c in a transport section therebetween.

The sensors 141b and 141c measure a transport time required for transport of the sheets P1 and P2 transported via the transport roller 131c in a transport section therebetween.

The sensors 141c and 141d measure a transport time required for transport of the sheets P1 and P2 transported via the transport rollers 131d and 131e in a transport section therebetween.

The sensors 141d and 141f measure a transport time required for transport of the sheets P1 and P2 transported via the transport rollers 131h and 131i in a transport section therebetween. The sensors 141d and 141e measure a transport time required for transport of the sheets P1 and P2 transported via the transport roller 131f in a transport section therebetween. The sensors 141d and 141g measure a transport time required for transport of the sheets P1 and P2 transported via the transport roller 131j in a transport section therebetween. The sensors 141d and 141h measure a transport time required for transport of the sheets P1 and P2 transported via the transport rollers 131j and 131k in a transport section therebetween.

The sensors 141e and 141c measure a transport time required for transport of the sheets P1 and P2 transported via the transport rollers 131g and 131c in a transport section therebetween.

For example, when transporting the sheets P1 and P2 in response to a print request or the like, the server apparatus 200 acquires, for the individual transport sections described above, measurement data of the measurement devices 141 disposed at both ends of the transport sections. Thereafter, the server apparatus 200 determines an error relating to the transport of the sheets P1 and P2 for each of the individual transport sections based on the acquired measurement data.

The server apparatus 200 manages the operation of the printer 100. For example, the server apparatus 200 receives, from the terminal device 300, a print instruction including text data, image data, a sheet size, a print surface regarding printing to the printer 100. Based on the print instruction issued by the terminal device 300, the server apparatus 200 issues a print request for transporting the sheets P1 and P2 of a predetermined size and performing printing on an instructed print surface. Then, the server apparatus 200 notifies the printer 100 of the issued print request, and causes the printer 100 to execute printing corresponding to the print instruction supplied from the terminal device 300.

Thereafter, the server apparatus 200 performs notification to the terminal device 300 based on the data obtained from the printer 100 after the notification of the print request. For example, in a case where there is a notification from the printer 100 that printing according to the print request has been completed, the server apparatus 200 notifies the terminal device 300 of the completion of printing. In addition, in a case where the measurement data measured by the sensor devices 140 during the execution of the printing satisfies a predetermined condition that causes an error, the server apparatus 200 notifies the terminal device 300 that an error has occurred during the printing.

The terminal device 300 is a computer device used by a user, and for example, a PC, a smartphone, or the like can be applied.

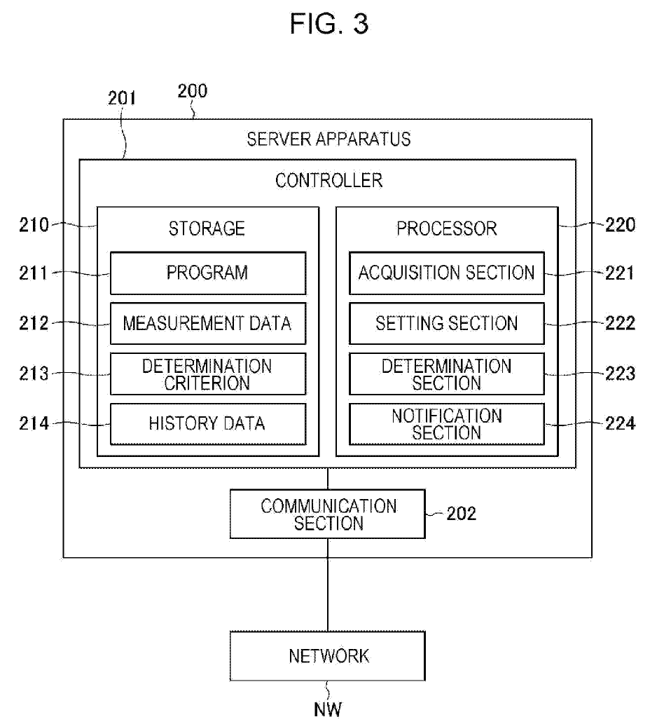

FIG. 3 is a diagram illustrating an example of a functional configuration of the server apparatus 200. As illustrated in FIG. 3, the server apparatus 200 includes a controller 201 and a communication section 202.

The controller 201 includes a storage 210 and a processor 220. The storage 210 includes, for example, a nonvolatile memory, such as a ROM, and a volatile memory, such as a RAM. The storage 210 may include an auxiliary storage device, such as an HDD or an SSD.

The storage 210 stores a program 211 for controlling operations of individual sections of the server apparatus 200, measurement data 212, a determination criterion 213, and history data 214 in the non-volatile memory or the auxiliary storage device. Furthermore, the volatile memory of the storage 210 is used as a work area when the processor 220 executes the program 211.

The measurement data 212 is measured by the sensor device 140 of the printer 100. Specifically, the measurement data 212 includes a measured value together with a measurement date and time. For example, the measurement data 212 includes a temperature and humidity, and the like of the printer 100 measured by the sensor device 140 together with the measurement date and time. Furthermore, the measurement data 212 includes, for each predetermined transport section, the measurement data of the measurement devices 141 provided at both ends of the transport section together with the measurement date and time.

The determination criterion 213 includes a determination criterion of an error relating to the transport of the sheets P1 and P2. For example, the determination criterion 213 includes a threshold value indicating an upper limit or a lower limit of the measurement data 212 for determining an error based on the measurement data 212 newly measured at the time of printing in the printer 100. Furthermore, the determination criterion 213 includes a section predicted as a range in which the measurement data 212 is to be included by the time-series analysis of the measurement data 212.

The history data 214 is data indicating a history relating to printing by the printer 100. Specifically, the history data 214 includes, in addition to print conditions, such as a printing date and time, a printing speed, a temperature, and humidity, an error determination result at the time of printing and the like in order of printing by the printer 100.

The processor 220 is an arithmetic processing device, such as a CPU or an MPU. The processor 220 may be configured by a single arithmetic processing device or may be configured by a plurality of arithmetic processing devices. Furthermore, the processor 220 may be configured by a portion or all of the storage 210 or an SoC integrated with other circuits. In addition, the processor 220 may be configured by a combination of a CPU that executes the program 211 and a DSP that executes predetermined arithmetic processing. Furthermore, all of the functions of the processor 220 may be implemented by hardware or may be configured using a programmable device. The communication section 202 is a communication interface that communicates with an external device via the network NW.

The processor 220 provides functions as an acquisition section 221, a setting section 222, a determination section 223, and a notification section 224 by reading the program 211 from the storage 210 and sequentially executing the program 211.

The acquisition section 221 is a processing section that acquires the measurement data 212 measured by the sensor device 140 from the printer 100. Specifically, the acquisition section 221 acquires the measurement data 212 measured by the sensor device 140 at the time of transport and printing of the sheets P1 and P2 in the printer 100. For example, when the transport mechanism 130 transports the sheets P1 and P2, the acquisition section 221 acquires, for each of the transport sections, the measurement data 212 of the measurement devices 141 provided at both ends of the transport section. Next, the acquisition section 221 stores the acquired measurement data 212 in the storage 210 together with a recording date and time.

The setting section 222 obtains the determination criterion 213 used for transport error determination in the printer 100 based on the time-series analysis of the measurement data 212 stored in the storage 210. Note that details of a process of obtaining the determination criterion 213 will be described later. Then, the setting section 222 stores the obtained determination criterion 213 in the storage 210 and sets the determination criterion 213.

The determination section 223 is a processing section that determines an error relating to the transport of the sheets P1 and P2 at the time of printing by the printer 100. Specifically, when the new measurement data 212 is acquired from the measurement devices 141 for each transport section, the determination section 223 determines an error relating to the transport of the new measurement data 212 based on the determination criterion 213 stored in the storage 210. Note that the details of the process relating to the error determination will be described later. The determination section 223 stores the determination result in the storage 210 as the history data 214 together with the print conditions in the printer 100.

The notification section 224 is a processing section that performs notification to the terminal device 300. For example, when receiving a notification of completion of printing according to a print request from the printer 100, the notification section 224 notifies the terminal device 300 of the completion of printing. In addition, when the determination section 223 determines an error relating to transport based on the new measurement data 212 acquired during the printing execution, the server apparatus 200 notifies the terminal device 300 that the error has occurred in the transport.

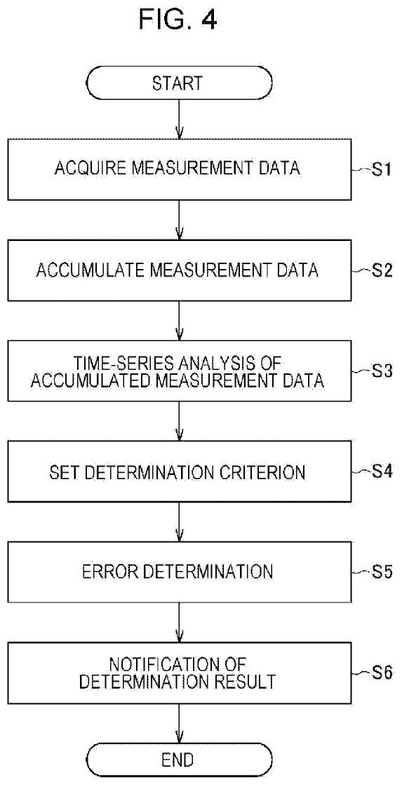

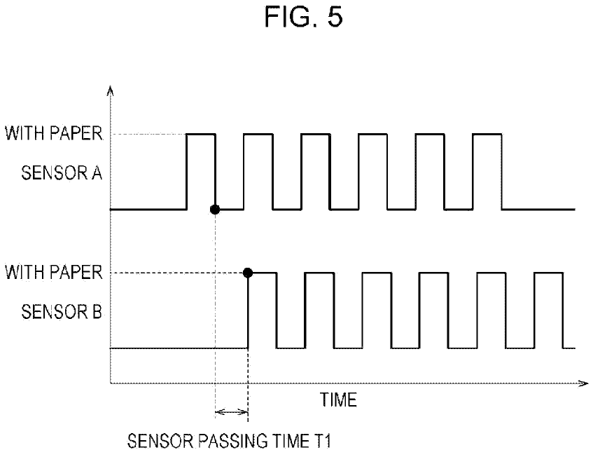

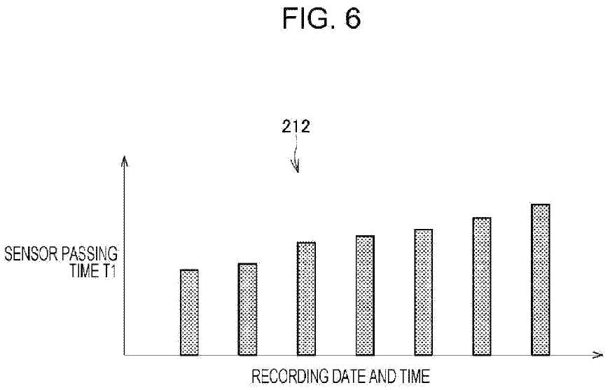

Next, details of a process in the server apparatus 200 will be described with reference to FIGS. 4 to 14. FIG. 4 is a flowchart illustrating an operation example of the server apparatus 200. FIG. 5 is an explanatory view illustrating a sensor passing time. FIGS. 6 to 13 are explanatory views illustrating examples of the measurement data 212.

First, an outline of the operation of the server apparatus 200 will be described with reference to FIG. 4. Note that, in FIG. 4, an example of an operation performed by the server apparatus 200 during a transport/print operation on the sheets P1 and P2 in the printer 100 is illustrated.

As illustrated in FIG. 4, when the process is started, the acquisition section 221 newly acquires measurement data 212 of transport sections relating to transport of the sheets P1 and P2 from the printer 100 (S1). Next, the acquisition section 221 adds recording date and times to the newly obtained measurement data 212 and then stores and accumulates the measurement data 212 in the storage 210 (S2).

Specifically, as illustrated in FIG. 5, the acquisition section 221 acquires, as the measurement data 212, a sensor passing time T1 that is a difference between detection times of the measurement devices 141 at both ends of each of the transport sections of the sheets P1 and P2. Note that, for convenience, the measurement device 141 at a front end of each of the transport sections (an end portion on the upstream side in a transport direction) is referred to as a sensor A, and the measurement device 141 at a rear end of each of the transport sections (the end portion on the downstream side in the transport direction) is referred to as a sensor B. The sensor passing time T1 between the sensor A and the sensor B is an example of a period of time required for transporting the sheets P1 and P2 in the transport section.

For example, in FIG. 2, it is assumed that the sheet P2 is transported to the print mechanism 120 by the transport rollers 131c and 131d. Then, the sheet P2 printed by the print mechanism 120 is transported to the second sheet discharge tray 134 by the transport roller 131j.

At this time, the acquisition section 221 acquires the sensor passing time T1 when the sheet P2 is transported by the transport roller 131c in a transport section in which the sensor 141b is the sensor A and the sensor 141c is the sensor B. Furthermore, after printing by the print mechanism 120, the acquisition section 221 acquires the sensor passing time T1 when the sheet P2 is transported by the transport roller 131j in a transport section in which the sensor 141d is the sensor A and the sensor 141g is the sensor B.

The acquisition section 221 stores the sensor passing times T1 of the individual transport sections acquired in this way in the storage 210 as the measurement data 212 after adding recording date and times.

FIG. 6 is an explanatory view illustrating an example of the measurement data 212. As illustrated in FIG. 2, the measurement data 212 includes the sensor passing times T1 for the individual recording date and times of the individual transport sections. That is, in the measurement data 212, the periods of time required for the transport of the sheets P1 and P2 are recorded in chronological order for individual transport sections.

Referring back to FIG. 4, after step S2, the setting section 222 performs time-series analysis on the past measurement data 212 accumulated for the transport sections relating to the transport of the sheet P1 and P2 (S3).

Specifically, the setting section 222 arranges the measurement data 212 accumulated for the transport sections in the order of recording date and time from the past. Subsequently, the setting section 222 predicts the measurement data 212 at a current time when the new measurement data 212 is acquired by extrapolation-based completion using the measurement data 212 arranged in the order of the recording date and time. More specifically, the setting section 222 calculates a confidence interval of the measurement data 212 at the current time with a predetermined reliability (X%).

As an example, the setting section 222 obtains an average and a standard deviation using the measurement data 212 arranged in the order of the recording date and time as a sample. Then, the setting section 222 calculates a confidence interval of the measurement data 212 at the current time, for example, with a reliability of 95%, based on the obtained average and the obtained standard deviation.

Subsequently, the setting section 222 sets the determination criterion 213 including the confidence interval of the measurement data 212 at the current time obtained by the time-series analysis performed on the accumulated past measured data 212 (S4).

The determination section 223 determines an error relating to the transport of the new measurement data 212 based on the measurement data 212 newly acquired in step S1 and the determination criterion 213 (S5). Thereafter, the notification section 224 notifies the terminal device 300 of a result of the determination determined by the determination section 223 with respect to the error relating to the transport (S6), and the process is terminated.

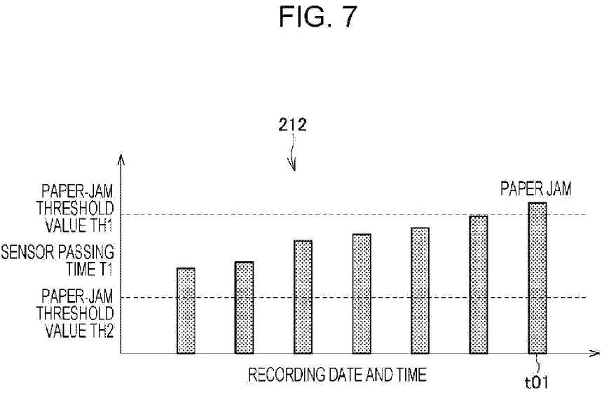

Here, the determination of an error in step S5 will be described in detail. For example, as illustrated in FIG. 7, a time point when the sensor passing time T1 is acquired as the new measurement data 212 is set as t01. Furthermore, it is assumed that the determination criterion 213 includes a paper-jam threshold value TH1 as an upper limit of the sensor passing time T1 for detecting "paper jam" which is paper jamming on a transport path. That is, the paper-jam threshold value TH1 is an example of a threshold value indicating an upper limit of a predetermined range corresponding to an error relating to transport of a medium. Similarly, it is assumed that the determination criterion 213 includes a paper-jam threshold value TH2 as a lower limit of the sensor passing time T1 for detecting "paper jam". That is, the paper-jam threshold value TH2 is an example of a threshold value indicating the lower limit of the predetermined range corresponding to the error relating to transport of a medium. Furthermore, it is assumed that the sensor passing time T1 at the time point t01 exceeds the paper-jam threshold value TH1.

When an error relating to transport is determined simply by comparing the paper-jam threshold values TH1 and TH2 with the sensor passing time T1, only a paper jam is determined.

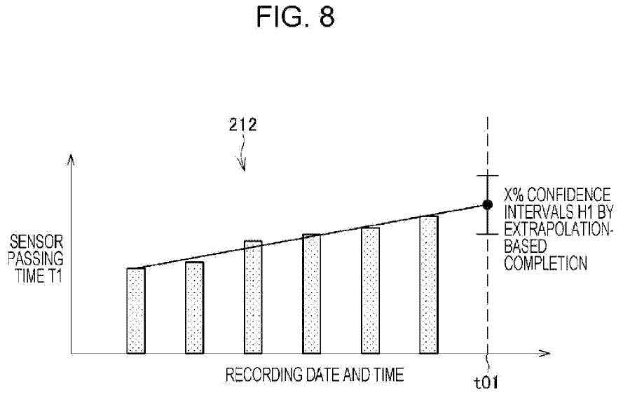

On the other hand, as illustrated in FIG. 8, the setting section 222 predicts, for the measurement data 212 at the time point t01, a confidence interval H1 with a reliability of the extrapolation-based completion of X% by the time-series analysis performed on the accumulated measurement data 212. The setting section 222 includes the confidence interval H1 predicted in this way in the determination criterion 213.

Next, the determination section 223 determines an error relating to the transport at the time point t01 based on the sensor passing time T1 at the time point t01 and the determination criterion 213 including the confidence interval H1.

Specifically, the determination section 223 determines a transport error location based on whether the sensor passing time T1 of the time point t01 is within a range from the paper-jam threshold value TH1 to the paper-jam threshold value TH2 and whether the sensor passing time T1 is within a range of the confidence interval H1.

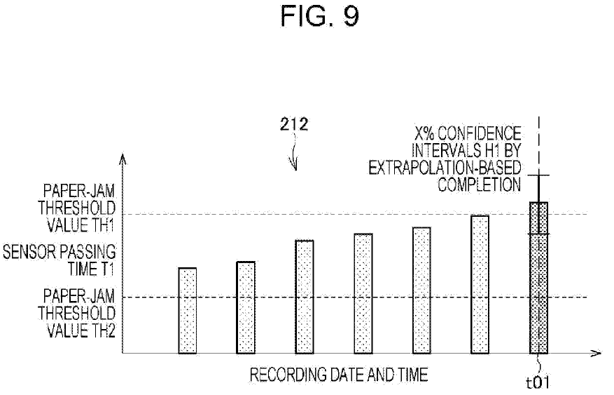

For example, as illustrated in FIG. 9, it is assumed that the sensor passing time T1 of the time point t01 is equal to or more than the paper-jam threshold value TH1 and is within the range of the confidence interval H1. In such a case, it can be estimated that the paper jam is not a sudden paper jam, but wear of the transport roller 131 progresses, and the sensor passing time T1 gradually increases to exceed the paper-jam threshold value TH1.

Therefore, the determination section 223 determines that the transport roller 131 relating to the transport section is broken or worn when the sensor passing time T1 at the time point t01 is equal to or more than the paper-jam threshold value TH1 and is within the range of the confidence interval H1. For example, as illustrated in FIG. 2, the determination section 223 determines that the transport roller 131c is broken or worn in the transport section in which the sensor 141b is the sensor A and the sensor 141c is the sensor B.

Here, the determination section 223 changes a value of the paper-jam threshold value TH1 to a larger value for a predetermined period of time after determining that the transport roller 131 relating to the transport section is broken or worn.

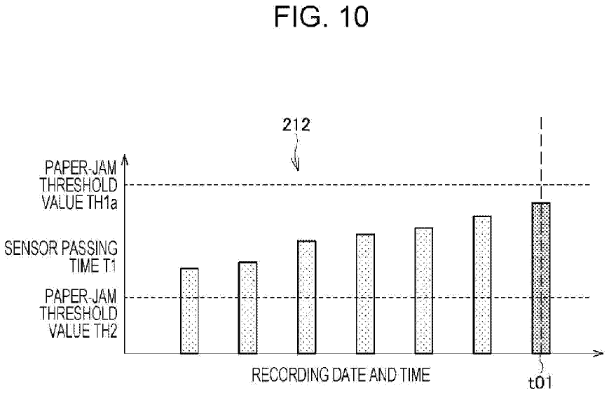

Specifically, as illustrated in FIG. 10, the determination section 223 changes the original paper-jam threshold value TH1 to a larger paper-jam threshold value TH1a. In this way, the determination section 223 temporarily increases an upper limit of the predetermined range corresponding to the error relating to the transport of the medium. As a result, in the server apparatus 200, it is possible to temporarily avoid an opportunity in which wear of the transport roller 131 which has progressed is detected as a paper jam error.

A period of the change is arbitrarily set by the user. For example, by setting the change period in accordance with a timing and a period of performing the maintenance, it is possible to avoid an error in which wear of the transport roller 131 or the like is determined as a paper jam until the next maintenance. In addition, it is possible to reduce downtime in which the printer 100 cannot be used due to an error.

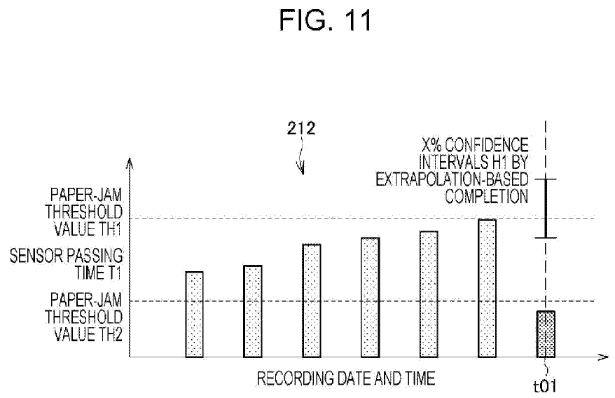

Furthermore, as illustrated in FIG. 11, it is assumed that the sensor passing time T1 of the time point t01 is equal to or less than the paper-jam threshold value TH2 and is out of the range of the confidence interval H1. In this case, it can be estimated as a detection failure due to contamination of the measurement devices 141.

Therefore, the determination section 223 determines that the measurement devices 141 relating to the transport section are broken or contaminated when the sensor passing time T1 at the time point t01 is equal to or less than the paper-jam threshold value TH2 and is out of the range of the confidence interval H1. For example, as illustrated in FIG. 2, the determination section 223 determines that the sensors 141b and 141c are broken or contaminated in the transport section in which the sensor 141b is the sensor A and the sensor 141c is the sensor B.

Here, the determination section 223 changes a value of the paper-jam threshold value TH2 to a smaller value for a predetermined period of time after it is determined that the measurement devices 141 relating to the transport section are broken or contaminated.

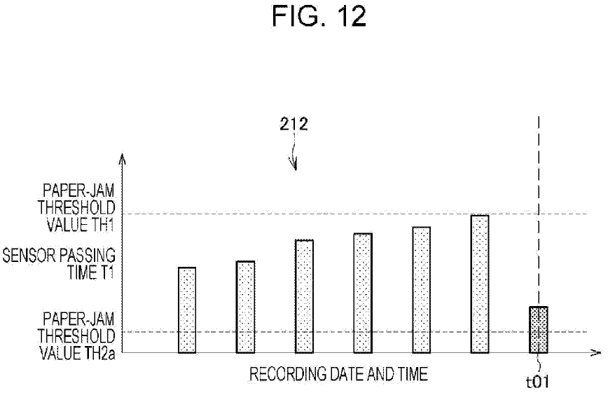

Specifically, as illustrated in FIG. 12, the determination section 223 changes the original paper-jam threshold value TH2 to a smaller paper-jam threshold value TH2a. In this manner, the determination section 223 temporarily decreases the lower limit of the predetermined range corresponding to the error relating to the transport of the medium. As a result, in the server apparatus 200, it is possible to temporarily avoid an opportunity in which contamination of the measurement devices 141 or the like is detected as a paper jam error.

A period of the change is arbitrarily set by the user. For example, by setting the change period in accordance with a timing and a period of performing the maintenance, it is possible to avoid an error in which contamination of the measurement devices 141 or the like is detected as a paper jam until the next maintenance. In addition, it is possible to reduce downtime in which the printer 100 cannot be used due to an error.

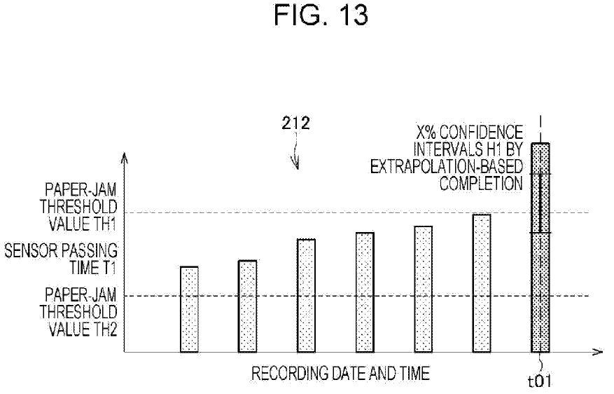

Furthermore, as illustrated in FIG. 13, it is assumed that the sensor passing time T1 of the time point t01 is equal to or more than the paper-jam threshold value TH1 and is out of the range of the confidence interval H1. In such a case, it can be estimated that wear of the transport roller 131 or the like has not occurred, but a sudden paper jam has occurred.

Therefore, the determination section 223 determines that a paper jam has occurred when the sensor passing time T1 at the time point t01 is equal to or more than the paper-jam threshold value TH1 and is outside the range of the confidence interval H1.

Furthermore, the notification section 224 may perform notification to the printer 100 so as to avoid a predetermined transport condition based on a past error included in the history data 214.

Specifically, the notification section 224 notifies the printer 100 to change the transport condition such that the transport is not performed under the transport condition determined as the error included in the history data 214.

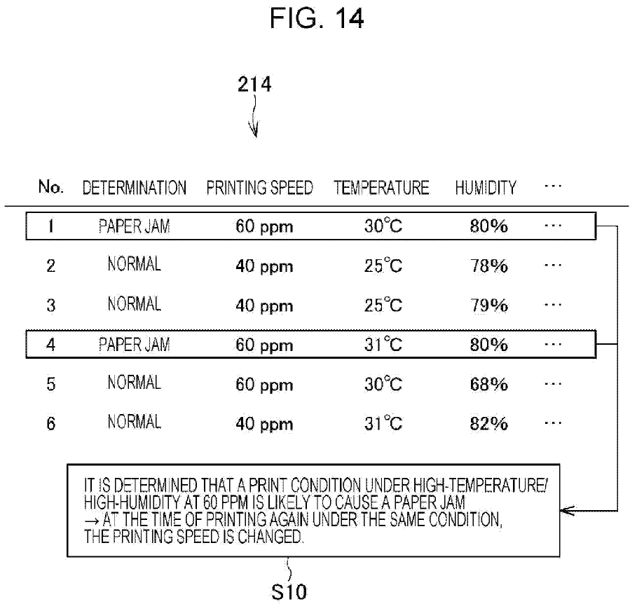

FIG. 14 is an explanatory view illustrating an example of the history data 214. As illustrated in FIG. 14, it is assumed that two paper jam errors have been recorded in the past in the history data 214. The notification section 224 acquires transport conditions, such as a printing speed, a temperature, and humidity, at times when the paper jams have occurred based on the paper jam errors included in the history data 214. In the illustrated example, under a relatively high-temperature and high-humidity environment in which a temperature is 30°C and a humidity is 80%, a paper jam error occurs under a transport condition of 60ppm (Page Per Minute).

Therefore, the notification section 224 notifies the printer 100 to set the transport condition to a condition other than 60ppm when printing is performed next time under the same condition in the same high-temperature and high-humidity environment. Specifically, the notification section 224 causes the printer 100 to change the transport condition by notifying the printer 100 of, in addition to information on the environment of the temperature and humidity at which the error occurs, the transport condition which causes the error under the environment. Note that the notification section 224 may notify a specific transport condition to be changed, such as less than 60ppm. As a result, the server apparatus 200 can suppress the next occurrence of an error.

The embodiment described above is a preferred embodiment of the present disclosure. However, the present disclosure is not limited to this embodiment, and various modifications may be made without departing from the scope of the present disclosure.

The individual functional sections included in the controller 201 illustrated in FIG. 3 indicate functional configurations realized by cooperation of hardware and software, and a specific implementation form is not particularly limited. Therefore, it is not always necessary to mount hardware individually corresponding to each functional sections, and it is also possible to adopt a configuration in which one processor 220 executes the program 211 to realize the functions of the plurality of functional sections. Furthermore, some of the functions implemented by software in the above-described embodiment may be implemented by hardware, and some of the functions implemented by hardware may be implemented by software.

In addition, for example, in the configuration of the controller 201 illustrated in FIG. 3, at least some of the acquisition section 221, the setting section 222, the determination section 223, and the notification section 224 may be configured by an integrated circuit or another digital circuit, and at least some of the sections may include an analog circuit. The integrated circuit includes an LSI, an ASIC, and a PLD. The PLD includes, for example, an FPGA. Each of the above sections may be a combination of the processor 220 and an integrated circuit. The combination is referred to as, for example, an MCU, an SoC, a system LSI, or a chip set.

In addition, the program 211 executed by the processor 220 in order to realize the above-described diagnosis method may be provided by being recorded in a recording medium readable by the processor 220. The recording medium readable by the processor 220 may be an optical recording medium, such as a DVD, a USB memory, a semiconductor memory device, such as an SSD, or the like. Furthermore, the program 211 may be stored in a computer connected to a network, such as the Internet, and may be provided in a form of a transmission medium provided or distributed by being downloaded via the network.

The processing units illustrated in the flowchart of FIG. 4 are divided according to the main processing contents for facilitating understanding of the processing performed by the processor 220, and the present disclosure is not limited by the manner in which the processing units are divided or by the names thereof in the flowchart of FIG. 4. In addition, the processing of the processor 220 may be divided into a larger number of processing units according to the processing contents and may be divided such that one processing unit includes more processes. In addition, the processing order of the above-described flowchart is not limited to the illustrated example.

### Summary of Present Disclosure

Hereinafter, appendixes to the present disclosure will be added.

### Appendix 1

A diagnostic apparatus includes a communication section that communicates with a transport apparatus that transports a medium, an acquisition section that acquires measurement data indicating a period of time required to transport the medium in a predetermined transport section on a transport path of the transport apparatus, a storage that stores the acquired measurement data, a setting section that sets a determination criterion used for error determination of the transport apparatus by time-series analysis performed on the stored measurement data, a determination section that determines, when measurement data is newly acquired from the transport apparatus, an error relating to transport of the new measurement data based on the new measurement data and the determination criterion, and a notification section that notifies a result of the determination of the error. The setting section sets the determination criterion at a time point when the new measurement data is acquired based on a tendency of a temporal change of the stored measurement data.

Accordingly, it is possible to appropriately determine the error relating to the transport based on the determination criterion according to the tendency of the temporal change of the measurement data.

### Appendix 2

In the diagnostic apparatus according to Appendix 1, the setting section sets the determination criterion including a predetermined confidence interval at the time point when the new measurement data is acquired by extrapolation-based completion based on the stored measurement data.

Accordingly, it is possible to more appropriately determine the error by the determination criterion in the predetermined confidence interval in the tendency of the temporal change of the measurement data.

### Appendix 3

In the diagnostic apparatus according to Appendix 2, the determination section determines an error location of the transport apparatus based on whether the new measurement data is within a predetermined range corresponding to the error relating to the transport of the medium and whether the new measurement data is within a range of the confidence interval.

Accordingly, it is possible to appropriately determine the error in combination with the predetermined confidence interval in the tendency of the temporal change of the measurement data.

### Appendix 4

In the diagnostic apparatus according to Appendix 3, when the new measurement data exceeds a first threshold value indicating an upper limit of the predetermined range corresponding to the error relating to the transport of the medium and is within the range of the confidence interval, the determination section determines that a roller relating to the transport section has a failure.

Accordingly, it is possible to determine the failure of the roller in the transport section.

### Appendix 5

In the diagnostic apparatus according to Appendix 4, the determination section sets a third threshold value larger than the first threshold value as an upper limit of the predetermined range corresponding to the error relating to the transport of the medium for a predetermined period of time after the determination of the failure of the roller.

Accordingly, it is possible to temporarily avoid the determination of the error relating to the failure of the roller.

### Appendix 6

In the diagnostic apparatus according to Appendices 3 to 5, when the new measurement data is less than a second threshold value indicating a lower limit of the predetermined range corresponding to the error relating to the transport of the medium and is outside the range of the confidence interval, the determination section determines that a sensor relating to the transport section has a failure.

Accordingly, it is possible to determine the failure of the sensor relating to the transport section.

### Appendix 7

In the diagnostic apparatus according to Appendix 6, the determination section sets a fourth threshold value smaller than the second threshold value as a lower limit of the predetermined range corresponding to the error relating to the transport of the medium for a predetermined period of time after the determination of the failure of the sensor.

Accordingly, it is possible to temporarily avoid the determination of the error relating to the failure of the sensor.

### Appendix 8

In the diagnostic apparatus according to any one of Appendices 3 to 7, when the new measurement data exceeds a first threshold value indicating an upper limit of the predetermined range corresponding to the error relating to the transport of the medium and is outside the range of the confidence interval, the determination section determines a jam of the medium in the transport section.

Accordingly, it is possible to determine a jam of the medium in the transport section.

### Appendix 9

In the diagnostic apparatus according to any one of Appendices 1 to 8, the storage stores history information including a transport condition at a time of the transport of the medium and the determination result of the error at the time of the transport, and the notification section transmits, to the transport apparatus, a request to change the transport condition to a second transport condition different from a first transport condition for the transport under a transport condition the same as the first transport condition that is determined as the error and that is included in the history information.

Accordingly, it is possible to avoid a transport condition that leads to a determination of an error, and it is possible to suppress an error.

### Appendix 10

In a system in which a transport apparatus that transports a medium and an information processing apparatus are connected to each other via a network, the information processing apparatus includes a communication section that communicates with the transport apparatus, an acquisition section that acquires measurement data indicating a period of time required to transport the medium in a predetermined transport section on a transport path of the transport apparatus, a storage that stores the acquired measurement data, a setting section that sets a determination criterion used for error determination of the transport apparatus by time-series analysis performed on the stored measurement data, a determination section that determines, when measurement data is newly acquired from the transport apparatus, an error relating to transport of the new measurement data based on the new measurement data and the determination criterion, and a notification section that notifies a result of the determination of the error. The setting section sets the determination criterion at a time point when the new measurement data is acquired based on a tendency of a temporal change of the stored measurement data.

Accordingly, it is possible to appropriately determine the error relating to the transport based on the determination criterion according to the tendency of the temporal change of the measurement data.

### Appendix 11

A diagnostic method causes a computer to execute acquiring measurement data indicating a period of time required to transport a medium in a predetermined transport section on a transport path of a transport apparatus that transports the medium, storing the acquired measurement data in a storage, setting a determination criterion used for error determination of the transport apparatus by time-series analysis performed on the stored measurement data, determining, when measurement data is newly acquired from the transport apparatus, an error relating to transport of the new measurement data based on the new measurement data and the determination criterion, and notifying a result of the determination of the error. In the setting, the determination criterion at a time point when the new measurement data is acquired is set based on a tendency of a temporal change of the stored measurement data.

Accordingly, it is possible to appropriately determine the error relating to the transport based on the determination criterion according to the tendency of the temporal change of the measurement data.

What is claimed is:

1. A diagnostic apparatus, comprising:
a communication section that communicates with a transport apparatus that transports a medium;
an acquisition section that acquires measurement data indicating a period of time required to transport the medium in a predetermined transport section on a transport path of the transport apparatus;
a storage that stores the acquired measurement data;
a setting section that sets a determination criterion used for error determination of the transport apparatus by time-series analysis performed on the stored measurement data;
a determination section that determines, when measurement data is newly acquired from the transport apparatus, an error relating to transport of the new measurement data based on the new measurement data and the determination criterion; and
a notification section that notifies a result of the determination of the error, wherein
the setting section sets the determination criterion at a time point when the new measurement data is acquired based on a tendency of a temporal change of the stored measurement data.

2. The diagnostic apparatus according to claim 1, wherein
the setting section sets the determination criterion including a predetermined confidence interval at the time point when the new measurement data is acquired by extrapolation-based completion based on the stored measurement data.

3. The diagnostic apparatus according to claim 2, wherein
the determination section determines an error location of the transport apparatus based on whether the new measurement data is within a predetermined range corresponding to the error relating to the transport of the medium and whether the new measurement data is within a range of the confidence interval.

4. The diagnostic apparatus according to claim 3, wherein
when the new measurement data exceeds a first threshold value indicating an upper limit of the predetermined range corresponding to the error relating to the transport of the medium and is within the range of the confidence interval, the determination section determines that a roller relating to the transport section has a failure.

5. The diagnostic apparatus according to claim 4, wherein
the determination section sets a third threshold value larger than the first threshold value as an upper limit of the predetermined range corresponding to the error relating to the transport of the medium for a predetermined period of time after the determination of the failure of the roller.

6. The diagnostic apparatus according to claim 3, wherein
when the new measurement data is less than a second threshold value indicating a lower limit of the predetermined range corresponding to the error relating to the transport of the medium and is outside the range of the confidence interval, the determination section determines that a sensor relating to the transport section has a failure.

7. The diagnostic apparatus according to claim 6, wherein
the determination section sets a fourth threshold value smaller than the second threshold value as a lower limit of the predetermined range corresponding to the error relating to the transport of the medium for a predetermined period of time after the determination of the failure of the sensor.

8. The diagnostic apparatus according to claim 3, wherein
when the new measurement data exceeds a first threshold value indicating an upper limit of the predetermined range corresponding to the error relating to the transport of the medium and is outside the range of the confidence interval, the determination section determines a jam of the medium in the transport section.

9. The diagnostic apparatus according to claim 1, wherein
the storage stores history information including a transport condition at a time of the transport of the medium and the determination result of the error at the time of the transport, and
the notification section transmits, to the transport apparatus, a request to change the transport condition to a second transport condition different from a first transport condition for the transport under a transport condition the same as the first transport condition that is determined as the error and that is included in the history information.

10. A system in which a transport apparatus that transports a medium and an information processing apparatus are connected to each other via a network, wherein
the information processing apparatus includes
a communication section that communicates with the transport apparatus,
an acquisition section that acquires measurement data indicating a period of time required to transport the medium in a predetermined transport section on a transport path of the transport apparatus,
a storage that stores the acquired measurement data,
a setting section that sets a determination criterion used for error determination of the transport apparatus by time-series analysis performed on the stored measurement data,
a determination section that determines, when measurement data is newly acquired from the transport apparatus, an error relating to transport of the new measurement data based on the new measurement data and the determination criterion, and
a notification section that notifies a result of the determination of the error, and
the setting section sets the determination criterion at a time point when the new measurement data is acquired based on a tendency of a temporal change of the stored measurement data.

11. A diagnostic method that causes a computer to execute:
acquiring measurement data indicating a period of time required to transport a medium in a predetermined transport section on a transport path of a transport apparatus that transports the medium;
storing the acquired measurement data in a storage;
setting a determination criterion used for error determination of the transport apparatus by time-series analysis performed on the stored measurement data;
determining, when measurement data is newly acquired from the transport apparatus, an error relating to transport of the new measurement data based on the new measurement data and the determination criterion; and
notifying a result of the determination of the error, wherein
in the setting, the determination criterion at a time point when the new measurement data is acquired is set based on a tendency of a temporal change of the stored measurement data.
